(19) United States
(12) Patent Application Publication
(10) Pub. No.: US 2008/0034204 A1
(43) Pub. Date: Feb. 7, 2008

(54) Communications Network Security Certificate Revocation

(76) Inventor: Anantharaman Lakshminarayanan, Singapore (SG)

Correspondence Address: PIETRAGALLO, BOSICK & GORDON LLP, ONE OXFORD CENTRE, 38TH FLOOR, 301 GRANT STREET, PITTSBURGH, PA, 15219-6404, US

(21) Appl. No.: 11/597,269

(22) PCT Filed: May 20, 2005
(86) PCT No.: PCT/SG05/00154

§ 371 Date: Sep. 26, 2007

Related U.S. Application Data
(60) Provisional application No. 60/573,524, filed on May 21, 2004.

(51) Int. Cl. H04L 9/00

(52) U.S. Cl. 713/158

(57) ABSTRACT

The distribution of security certificate revocation information on a communications network is disclosed. An issuer node (82) of said network periodically generates data representative of base certificate revocation lists (CRLs) (10). The issuer node (82) periodically generates data representative of incremental CRLs (50), the incremental CRL data (50) including attributes for a current list of revoked certificates and a digital signature of the most-recent base CRL (10). A relying node (86) requests current incremental CRL data (50) from the issuer node (82). The relying node (86) reconstructs said most-recent base CRL by iteratively updating the list of revoked certificates present in the previous base CRL data held with the list of revoked certificates held by any intervening incremental CRL data (50). Additional forms of milestone CRL data (60) and augmented CRL data (70) are also disclosed.

### FIELD OF THE INVENTION

This invention relates to the field of security certificates in communications networks, and particularly to the distribution of security certificate revocation information.

### BACKGROUND

The Internet has in recent times become an indispensable communication platform. Enterprises need security to protect communications with their employees and customers, especially since the Internet runs on public networks. The most popular network security protocol used by Internet clients and servers is secure socket layer (SSL) that relies on public key cryptography and X.509 certificates.

The X.509 certificate standard (“Information technology—Open systems interconnection—The directory: Public-key and attribute certificate frameworks”, ITU-T Recommendation X.509 (V4), 2000.) was published by the ITU (International Telecommunication Union) and the ISO (International Organization for Standardization) in 1998, and since has been adopted by IETF's PKIX working group. The X.509 certificate is used to bind a public key to an individual or entity, and is digitally signed by a Certificate Authority (CA), the issuer of the certificate. However, use of SSL has been limited more or less to server-side authentication that requires server certificates only. Client certificates are not widely used for reasons such as mobility of client credentials, revocation support and implementation cost.

One popular mechanism of distributing certificate revocation information has been periodically issued, digitally signed certificate revocation lists (CRLs). A CRL is a time-stamped list of serial numbers or other certificate identifiers for those certificates that have been revoked by a particular CA. The CRL is signed by the relevant CA and made freely available in a public repository. Updates need to be issued at regular intervals, even if the list has not changed, to enable users possessing a CRL to check that the list is current. Any revoked certificates should remain on the list until their scheduled expiry date.

The X.509 standard defines a standard CRL format 10, as shown in FIG. 1. The X.509 CRL format consists of:
the version of the CRL format 12
the signature algorithm for the CRL issuer's signature 14
the issuer's X.500 name 16 (assigned by a naming authority)
‘This Update’ 18: the date and time of issuer of the CRL
‘Next Update’ 20: the date and time by which the next CRL will be issued
CRL extensions 22 (e.g. base CRL number)
Revoked certificate information 24, being a list of revoked certificates, including certificate serial number (the serial number of a revoked or suspended certificate), the revocation date, and the CRL entry extensions providing additional fields such as a reason for revocation, and
the digital signature 26 of the CA over the information included in the CRL.

CRLs are advantageous because they are reasonably cheap and the CRL data structure is a signed statement from the CA, and hence CRLs can be distributed using mechanisms similar to certificate distribution, such as an LDAP server. However, for large user populations, the CRL size can become large and can consume excessive bandwidth.

To alleviate some of these problems, a special type of CRL—called delta-CRLs—can be used. A delta-CRL is a digitally signed list of the changes that occurred since the issuance of a (prior) base CRL. The base CRL is identified using a special extension, the ‘CRL indicator extension’, carried by the delta-CRL. Base CRLs are typically issued less frequently (e.g. every hour) and delta-CRLs more frequently (e.g. every 15 minutes). The delta-CRL can be used to update the current list of revoked certificates without the need to download the complete CRL, which can save considerable bandwidth resources especially in large user populations.

The structure of a delta-CRL 30, as shown in FIG. 2, and is very similar to a base CRL 10. A X.509 delta-CRL 30 includes:
a version identifier 32
a signature algorithm 34
a CRL issuer's name 36
‘This Update’ information 38
‘Next Update’ information 40
the delta-CRL indicator extension 42
a list 44 of certificates revoked since the base CRL was issued (each member including a serial number, revocation date and CRL entry extension), and
a CA digital signature 46.

The packet size of a delta-CRL 30 typically is:
CRL Header (45 bytes)
   Issuer's name: 32 bytes
   Two dates: 12 bytes
   Algorithm Identifier: 1 byte
Signature bit string: 128 bytes (1024 RSA)
List of revoked Certificates (9 bytes per revoked certificate)
   3 bytes for serial number
   6 bytes for revocation date
ASN.1 packaging data
CRL number extension

Hence the size of a delta-CRL is approximately 180+9*Number of revoked and unexpired certificates.

CRL schemes, including delta-CRL schemes, suffer from a time latency problem. During the interval between a freshly issued CRL and its next update, if a revocation occurs and is made known to the relevant revocation authority, the users of the public key infrastructure (PKI) will be unaware of the revocation. For some systems, this might be acceptable as long as the update period is not very long, although the CRL update interval might vary depending on the application, and can vary from 5 minutes to as much as one week.

As a supplement to checking against a periodic CRL, it may be necessary to obtain timely information regarding the revocation status of a certificate. The online certificate status protocol (OCSP) mechanism (see RFC 2560, http://www.ietf.org/rfc/rfc2460.txt) enables software applications to determine the status of a certificate in a timely manner but with a much higher operational cost. An OCSP client issues a status request to an OCSP responder and suspends acceptance of the certificate in question until the responder provides a response. Acquiring and managing trusted online servers with appropriate cryptographic processing resources capable of generating a time stamped digital signature for each status request is expensive, however, especially when the PKI environment scales up.

It is a preferred object of the invention to improve on the delta-CRL scheme without incurring significant processing or bandwidth requirements.

### SUMMARY

The invention broadly provides a method for distributing security certificate revocation information on a communications network. The method includes the steps of an issuer node of the network periodically generating data representative of base certificate revocation lists (CRLs). The issuer node periodically generates data representative of incremental CRLs, the incremental CRL data including attributes for a current list of revoked certificates and a digital signature of the most-recent base CRL.

The invention further broadly provides an issuer node on a communications network for distributing security certificate revocation information to relying nodes, including processor means for periodically generating data representative of base certificate revocation lists (CRLs), and periodically generating data representative of incremental CRLs, said incremental CRL data including attributes for a current list of revoked certificates and a digital signature of the most-recent base CRL.

The invention yet further broadly provides a relying node on a communications network for requesting security certificate revocation information from an issuer node, including processor means for reconstructing the most recent base CRL by iteratively updating the list of revoked certificates present in the previous base CRL data held by the relying node with the list of revoked certificates held by any intervening incremental CRL data received from said issuer node.

The invention yet further broadly provides a computer program product comprising a computer program stores by a storage medium, said computer program providing machine readable code that when executed performs the steps of periodically generating data representative of base certificate revocation lists (CRLs), and periodically generating data representative of incremental CRLs, said incremental CRL data including attributes for a current list of revoked certificates and a digital signature of the most-recent base CRL.

The invention yet further broadly provides a computer program product comprising a computer program stores by a storage medium, said computer program providing machine readable code that when executed performs the steps of reconstructing a most-recent base CRL by iteratively updating the list of revoked certificates present in the previous base CRL data with the list of revoked certificates held by any intervening incremental CRL data.

### BEST DESCRIPTION OF THE DRAWINGS

FIG. 1 shows a known X.509 CRL data structure.

FIG. 2 shows a known X.509 CRL data structure and a delta-CRL data structure.

FIG. 3 shows a X.509 base CRL data structure and an incremental-CRL data structure.

FIG. 4 shows a X.509 milestone CRL data structure.

FIG. 5 shows a timeline of when base, incremental and milestone CRLs are respectively issued.

FIG. 6 shows a timeline of when incremental-, milestone- and augmented-CRLs are issued.

FIG. 7 shows an incremental CRL data structure and an augmented CRL data structure.

FIG. 8 shows a schematic block diagram of a client-server computer architecture upon which the invention can be embodied.

FIG. 9 shows a schematic block diagram of a computer architecture for an issuer or relying node.

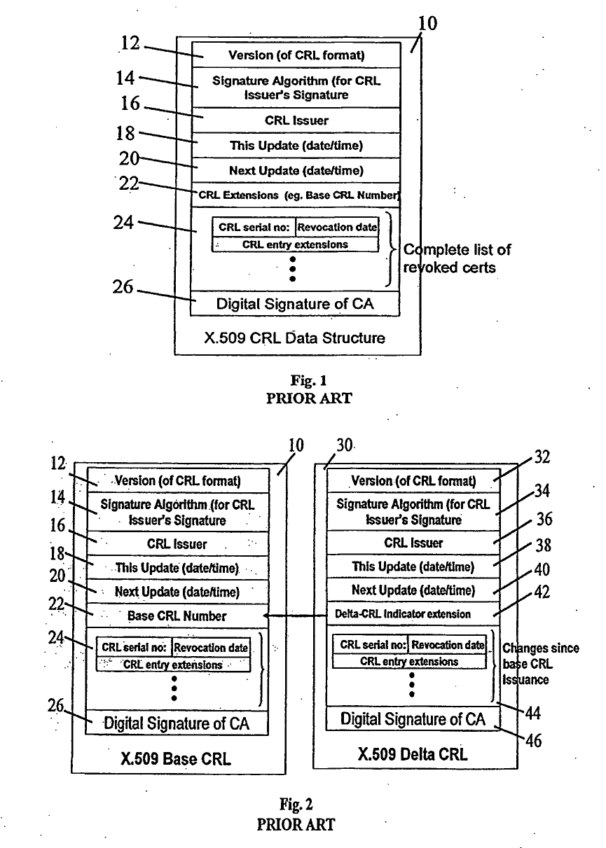

### DETAILED DESCRIPTION

A. Introduction

The embodiments described below relates to X.509 certificates, however it is to be understood that the invention is not limited to such an implementation.

The attributes of the CRL 10 that change every time a new periodic CRL is issued are:
1) ‘This Update’ 18
2) ‘Next Update’ 20
3) CRL number (if included) 22
4) the list 24 of revoked certificates, and
5) the CA signature 26 over the CRL data structure

The list of revoked certificates typically doesn't change much, except for additions made because of fresh revocations during the last revocation time interval and deletions of revoked certificates because of their expiry. The list of revoked certificates can be present in any order. However this list can also be an ordered list such as an ascending order using the certificate serial number. Such an ordered list can be indicated using a special X.509 CRL extension: the ordered list extension.

Consider the following set of conditions:
all CRLs have CRLNumbers
delta-CRLs refer to base CRLs using the base CRL's CRLNumber
the list of revoked certificates is ordered
when a delta-CRL is issued, a base CRL is also issued at the same time (though clients need not download this base CRL)
‘thisUpdate’ and ‘nextUpdate’ fields of base CRL and delta-CRL issued at the same time are same
the CRLNumber of base CRL and delta-CRL issued at the same time is same
the type of CRL (e.g. base, delta) is distinguished by their extensions, and
the CRL extensions do not change with time.

If the client possesses the base CRL that the delta-CRL refers to, then using delta-CRLs 30, it is clear that a client possesses all attributes of the base CRL 10 (issued at the same time as the delta-CRL 30) except for the digital signature 26 of CRL issuer over the contents of base CRL 10.

B. Incremental-CRL Data Structure

Signature Extension

A modified form of delta-CRL data structure 30 is shown in FIG. 3, termed the incremental-CRL 50. Attributes that are common with a delta-CRL 30 are shown using common reference numerals. An incremental-CRL 50 contains the CRL issuer's digital signature 26 over the contents of the base CRL 10 (that was issued at the same time as the delta-CRL 30) as a private X.509 CRL general extension 52. A client possessing an incremental-CRL 50 can construct the base CRL 10 (that was issued at the same time) since it possesses all attributes of the base CRL 10, which are:
CRLNumber 42 (same for base CRL and delta-CRL issued at the same time)
thisUpdate, nextUpdate fields 38,40 (same for base CRL and delta-CRL issued at the same time)
An ordered list 44 of all revoked certificates in the base CRL 10. (This is a union of the revocation list of the base CRL 10 that the incremental-CRL 50 refers to and the list 44 contained in the incremental-CRL 50. Deletions from this list are ignored due to certificate expiry), and
The digital signature 26 of CRL issuer over the base CRL contents contained in the private extension 52 of the incremental CRL.

An incremental-CRL 50 is many times smaller than a base CRL 10 and hence will result in considerable bandwidth savings. A locally constructed base CRL 10 can be distributed to other clients since this CRL is identical to the one signed by the CRL issuer. The size of an incremental-CRL 50 will be slightly larger than a delta-CRL 30 because of inclusion of the extra private extension 52, which will be around 130 bytes (using 1024 bit RSA+ASN.1 packaging).

Milestone CRLs

Once a revoked certificate has expired, it need not be present in the CRL. In schemes using delta-CRLs, a client constructs the latest list of revoked certificates from the list of revoked certificates present in the newly issued delta-CRL 30 and the list present in the base CRL 10 (that is referenced by the delta-CRL 30). The CRL issuer regularly removes expired certificates from the base CRL 10. But a client which downloads only incremental-CRLs has no information about revoked certificates that have expired.

Use of a special CRL entry extension can overcome this problem by having the reason code extension with the reason code set to “remove from CRL”. This indicates that an entry that was present in a base CRL 10 or a subsequent incremental-CRL 50 should be removed either because a certificate suspension has been released or that a revoked certificate has expired.

Since relying parties definitely need to download this list of “removed” certificates from the list of revoked certificates to prepare the updated list of revoked certificates, it is necessary that there are certain milestone CRLs that contain these lists of certificates that have to be removed from the CRL list. These ‘milestone CRLs’ are analogous to base CRLs, except that instead of containing only a complete list of revoked certificates, they also will contain a list of certificates that need to be removed from the CRL list.

Milestone CRLs can be implemented as a special X.509 extension to indicate that the CRL is carrying information about the certificates that need to be dropped from the list of revoked certificates. The ‘reason code’ needs to be included along with other revocation details such as certificate serial number, time of revocation etc. This however is a rather expensive mechanism to handle expired certificate because of a redundant piece of information: the revocation time.

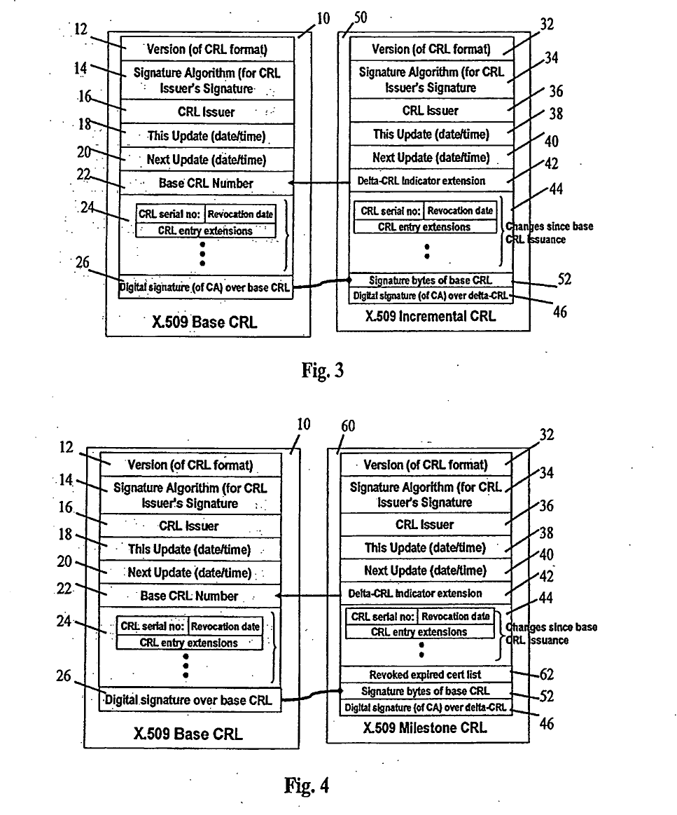

To address this issue of expired certificates, two types of incremental-CRLs are used. One is the (ordinary) incremental-CRL described above, and other an (incremental) milestone-CRL 60. Both forms of incremental-CRL carry the signature bytes 52 of a base CRL 10 issued at the same time. As shown in FIG. 4, an (incremental) milestone-CRL 60 carries an additional X.509 CRL general extension 62 containing the list of the revoked certificates that have expired and need to be removed when constructing a base CRL 10. This list consists of all expired revoked certificates since the issuance of the previous incremental milestone-CRL. This private extension 62 also indicates when the next milestone-CRL will be issued. The other attributes of the milestone-CRL 60 are common with the incremental-CRL 50.

Incremental CRLs are issued at regular intervals and clients download them to locally construct base CRLs 10. A milestone-CRL 60 is issued every T interval and an incremental CRL 50 every kT interval (p incremental CRLs issued every T interval where k*p=1). A base CRL 10 is issued every time an incremental-CRL (both ordinary and milestone) 50, 60 is issued, and base CRLs 10 that are issued with milestone-CRLs 10 serve as reference base CRLs. An incremental-CRL 50 refers to a milestone-CRL 60 in the same way a delta-CRL 30 refers to a base CRL, that is, using the DeltaCRLIndicator extension 42. In this sense, a milestone-CRL 60 is analogous to a base CRL 10 (of the traditional delta-CRL scheme). The size of a milestone-CRL 60 is marginally larger since it carries the list of expired revoked certificates.

FIG. 5 shows a timeline indicating when the incremental-CRLs 50 and milestone-CRLs 60 are issued with respect to one another.

Construction of Base CRLs

A CRL server will normally issue a base CRL 10 for every issuance of an incremental-CRL 50, however clients need not download these base CRLs. Clients can locally construct the base CRL 10 using only a downloaded most recent incremental-CRL 50 and a most recent milestone-CRL.

Consider that:
1) the issuer name 16 is the same as included in the delta-CRL issuer attribute 36
2) the current CRL number 22 is included in the special extension attribute 52 or might be present in the general CRL extension
3) the date and time attributes 38, 40 will be the same as that of the base CRL attributes 18, 20
4) the list of revoked certificates can be obtained from the base CRL 10 and the delta-CRL lists 44 issued at the same time as the incremental-CRL 50 or a milestone-CRL 60, and
5) the digital signature of the base CRL 26 is included in the special extension 52.

Hence it is possible to locally construct the base signed CRL 10. Assume that a client system currently possesses baseCRL₁₀, and the latest base CRL is baseCRL₂₀. The CRL distribution server is advised by the client that it holds baseCRL₁₀. The CRL distribution server sends the client system the milestone-CRLs issued in the time between baseCRL₁₀ and baseCRL₂₀. The client system then iteratively constructs baseCRL₂₀ by firstly constructing baseCRL₁₁, then baseCRL₁₂, and so on. To construct completely the base CRLs locally, the client needs the base CRL signature over the contents of the base CRLs. This signature is present in the incremental-CRLs (both ordinary and milestone types) as an extra extension 52.

This process is further explained as follows:
Step 1: list of revoked certificates of baseCRL_{Ti+1}=revocation list of baseCRL_{Ti}+revocation list of milestoneCRL_{Ti+1}−list of expired certificates in milestoneCRL_{Ti+1}
Step 2: construct baseCRL_{Ti+1} iteratively: The issuer name for the baseCRL_{Ti+1} and the milestoneCRL_{Ti+1} are the same. The “thisUpdate” and “nextUpdate” attributes are also the same. The CRL number is the same. The list of revoked certificate of baseCRL_{Ti+1} is obtained in step 1. This list is an ordered list. The CA's signature over the baseCRL_{Ti+1} is present as an extension 52 in the milestoneCRL_{Ti+1}. (If the client system doesn't have baseCRL_{Ti}, but has baseCRL_{Ti-1}, the client can use Step 1 and 2 to first construct baseCRL_{Ti} This is an iterative process and hence the client can construct the latest base CRL using its last used base CRL 10 and all the milestone-CRLs 50 issued between the last used base CRL 10 that the client possesses and the latest base CRL 10 issued by the CA).
Step 3: list of revoked certificates of baseCRL_{Ti+1+nkT}=revocation list of baseCRL_{Ti+1}+revocation list of incremental CRL_{Ti+1+nkT}
Step 4: construct baseCRL_{Ti+1+nkT}. The issuer name for the baseCRL_{Ti+1+nkT} and incrementalCRL_{Ti+1+nkT} are the same. The “thisUpdate” and “nextUpdate” attributes are also the same. The CRL number is the same. The list of revoked certificate of baseCRL_{Ti+1+nkT} is obtained in step 3. The CA's signature over the baseCRL_{Ti+1+nkT} is present as an extension 52 in the incrementalCRL_{Ti+1+nkT}, hence the client system has all the attributes of the BaseCRL_{Ti+1+nkT}.

Missed Base CRLs

Clients can become inactive and fail to download one or more milestone-CRLs 60. In the traditional delta-CRL scheme, a client needs to download only one base CRL 10 and a delta-CRL 30 to generate the latest list of revoked certificates regardless of how long it has been inactive. However, with the present incremental-CRL scheme, a client needs to download all missed milestone-CRLs 60. Otherwise, the client will not be able to construct the latest base CRL 10 locally, since it will not have the complete list of revoked certificates as well as the list of expired revoked certificates. Unless the client has been inactive for a long time, the total size of milestone-CRLs 60 to be downloaded will be small. A CRL distribution server stores all milestone-CRLs 60 that were issued by the CRL issuer in the past. Since milestone CRLs are small, this is a small resource price to pay for the considerable bandwidth savings that are otherwise achieved.

When a client receives a set of incremental-CRLs 50 from a CRL distribution server, it first checks whether the signature over each CRL is valid (if RSA is used as the signature algorithm, signature verification is relatively cheap, if a low exponent is used). Each milestone-CRL 60 also contains in its private extension the date and time the next milestone-CRL 60 is issued. Using this attribute, the client should verify whether it has obtained all milestone-CRLs. The client then iteratively constructs all base CRLs 10 that have been issued in the past till the latest issued base CRL. A protocol between the client and CRL distribution server for obtaining the latest CRL information is:
Client sends the CRLNumber of the last base CRL 10 it retrieved (or possesses).
The server sends all milestone-CRLs 60 and the latest incremental-CRL 50 that are necessary for client to compute the latest base CRL 10.
The client then iteratively constructs base CRLs 10 until it constructs the latest base CRL 10.
If client sends −1 (instead of a CRLNumber), then the latest base CRL is sent by the server.

Discussion of Advantages

The incremental-CRL scheme has many advantages over the known delta-CRL scheme.
The size of the incremental-CRLs (with the signature extension) can remain small and hence save significant band-width, especially in large user populations.
In traditional delta-CRL schemes, the base CRL issuance needs to be kept quite infrequent. This however means that the size of the delta-CRL will grow. In the incremental-CRL scheme, this issue doesn't arise at all. Milestone CRLs can be issued frequently ensuring that the size of incremental-CRLs remain really small.
The user need not download the base CRL at any time. The relying user can keep on updating and reconstructing the current complete CRL.
A relying party need not maintain a secure storage since it can construct a complete CRL using the above scheme and the complete CRL is protected by the certificate authority's signature. The list of revoked certificates is also ordered and facilitates easier processing for the relying party
There is no need to alter the format of the CRL. The use of a simple extra extension, the signature extension is sufficient.
Moreover applications that use the traditional delta-CRL scheme can continue doing so. They just ignore the extra signature extension. Hence it is backward compatible.

C. Augmented-CRL Scheme

The augmented-CRL scheme is an extension of the incremental-CRL scheme, and may be thought of as a ‘delta-delta CRL scheme’. Referring now to the timeline of

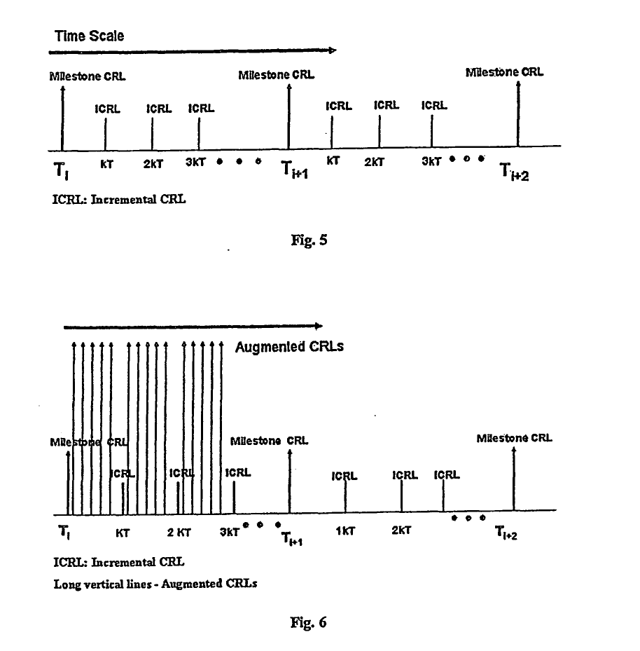

FIG. 6, incremental-CRLs 50 and milestone CRLs 60 are issued regularly, as before. In addition, augmented-CRLs 70 are issued much more frequently, typically every minute or even every 30 seconds, and contain the list of certificates that were revoked after the last (most recent) incremental-CRL 50 was issued. There is thus a hierarchy: an augmented-CRL 70 is in relation to an incremental-CRL 50, as an incremental-CRL 50 is in relation to a milestone-CRL 60.

It is reasonable to assume that the clients will cache the most recent base CRL 10 that they have constructed using the most recently downloaded milestone- and incremental-CRLs 60, 50. The reason for using augmented-CRLs is because their sizes will be smaller than incremental-CRLs and hence provide more bandwidth savings to the revocation authority.

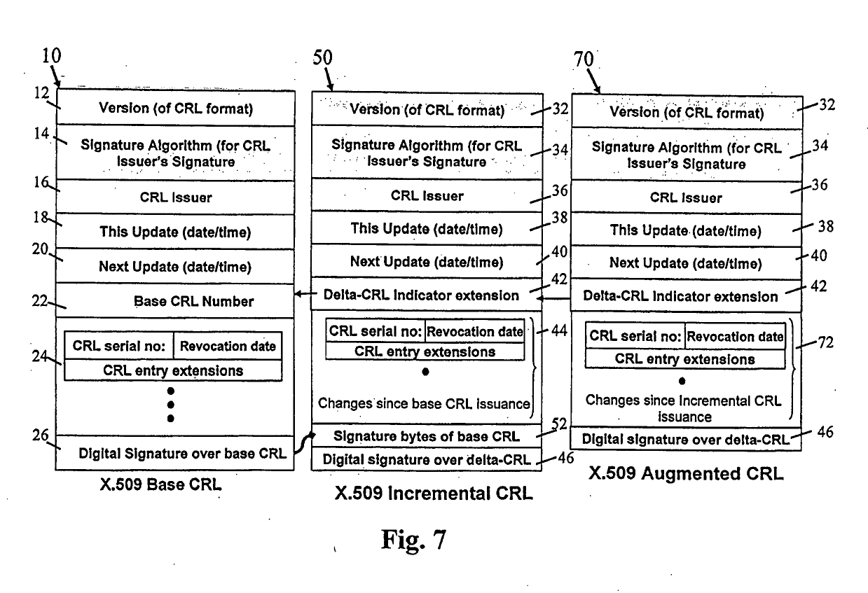

Referring now to FIG. 7, the data structure of an augmented-CRL 70 is very similar to that of a delta-CRL 30. It contains a delta-CRL extension 72 to indicate that CRL Number of the incremental-CRL 60 it is issued in relation to.

However there is an extra V3 extension, which should be marked non-critical. This extension is the acceptable time delay factor. Since system clocks of relying parties and the revocation server might not be synchronized, relying parties should reject augmented-CRLs which do not fall into an acceptable time range.
Time_{relying party}−Δ_{accept}≦Time_{revoc server}≦Time_{relying party}+Δ_{accept}

For example, assume that the revocation server issues an augmented-CRL 70 according to its time at, for example, at 11:30:30 AM and the update period of the augmented-CRL 70 is 30 seconds. If the clocks are out of synchrony by more than 30 seconds, then it is possible for the relying party not to obtain the latest CRL. Hence the time difference should be within acceptable limits. Otherwise, the client needs to resynchronize.

Since it is desirable that the size of the augmented-CRL 70 be small, CRL entry extensions can be avoided in this data structure. They can be included in the next issued incremental-CRL 50.

Moreover, in most cases, the revocation status at T and T+Δ (Δ being the time interval between two augmented-CRLs) will most probably be the same. Hence augmented-CRLs 70 can be pre-created and released at the appropriate time.

As discussed above, incremental-CRLs 50 are used to construct (at the client side) the base CRLs 10 issued at the same time. Augmented-CRLs 70 refer to incremental-CRLs 50 (in fact, it is the base CRLs 10 issued at the same time as the incremental-CRL 50). The base CRL 10 issued at the same time as the augmented-CRL 70 is constructed using the same process as for incremental-CRLs described above, if the augmented-CRLs 70 also carry the signature bytes 26 of the base CRL 10 issued at the same time as the signature extension 52.

If the augmented-CRLs 70 do contain the signature bytes 26 of the base CRL issued at the same, then the following steps can be used to construct the complete baseCRL without having to download it. Assume that baseCRL_{aug} is the baseCRL issued at the same time as the augmented CRL. Let the augmentedCRL refer to the base CRL_{incr} issued at the same time as the latest incremental-CRL (and constructed locally using steps 1 to 4 given above). Thus:
Step 1: the list of revoked certificates of baseCRL_{aug}=revocation list of baseCRL_{incr}+revocation list of augmented-CRL
Step 2: The issuer name for the baseCRL_{aug} and augmentedCRL re the same. The “thisUpdate” and “nextUpdate” attributes are also the same. The CRL number is the same. The list of revoked certificate of baseCRL_{aug} is obtained in step 1 (immediately above). The CA's signature over the baseCRL_{aug} is present as a extension in the augmentedCRL. Hence the client has all the attributes of the BaseCRL_{aug}. So the client can construct the BaseCRL_{aug} without having to download it.

Skipped Incremental- and Milestone-CRLs

There will be instances where when a user requests revocation information, the latest incremental-CRL 50 might not have been downloaded. Hence the server needs to send back not only the relevant augmented-CRL 70 but also all the previous incremental-CRLs 50 that are necessary to construct the latest base CRL 10. The following protocol is used between the client and CRL distribution server for obtaining the latest CRL information:
Client sends the CRLNumber of the last base CRL 10 it retrieved (or possesses).
The server sends all milestone-CRLs 60 and the latest incremental-CRL 50 that are necessary for client to compute the latest base CRL 10. The server also sends the latest augmented CRL 70.
The client then iteratively constructs base CRLs 10 until it constructs the latest base CRL 10. The client then uses the augmented-CRL 70 as a delta-CRL in comparison to the latest base CRL 10.
If client sends −1 (instead of a CRLNumber), the latest base CRL 10 is sent by the server.

There are a number of advantages of augmented-CRLs over existing real-time revocation status protocols such as OCSP.
i) Unlike in the OCSP scheme, the signing key need not be present on an online server or on a machine connected to an online server. There is no need for an authorized signer. This makes the entire system more secure. The cryptographic infrastructure needed for this scheme is much simpler.
ii) The number of digital signatures that the revocation server needs to create is also quite small. Assuming that if an augmented-CRL is issued every 10 seconds, then in one hour only 360 digital signatures need to be created at all user request loads. If, on the other hand, OCSP is and assuming 3 million requests a day, the server will need to create 3 million signatures a day.
iii) This system is highly scalable, compared to the OCSP scheme because each request doesn't need a signed response. Moreover it is less vulnerable to denial of service attacks compared to OCSP servers.
iv) Using the augmented-CRL scheme, a relying user can obtain revocation status of all the certificates in that PKI environment. In OCSP, you get a response for each certificate whose status is requested.
v) The CRLs are integrity protected by the CA's signature. Hence they can be easily distributed and/or cached by intermediate nodes/users
vi) The entire system is backward compatible. Existing systems that rely on CRLs need not make any change.
vii) The CA can provide a graded revocation service. Users requesting for real-time information can be provided the service at an extra cost. However the relying system need not be changed when the user requirements change. Clients that do not need real-time revocation will not be forced to change their systems if they are currently using CRL schemes.
viii) Since the cost of generating augmented-CRLs isn't prohibitive, the time granularity of augmented-CRL updates can be reduced as much as possible until reducing it further makes no practical sense. Moreover the augmented-CRLs can even be pre-generated and released at appropriate time.

D. Computer Architecture Implementation

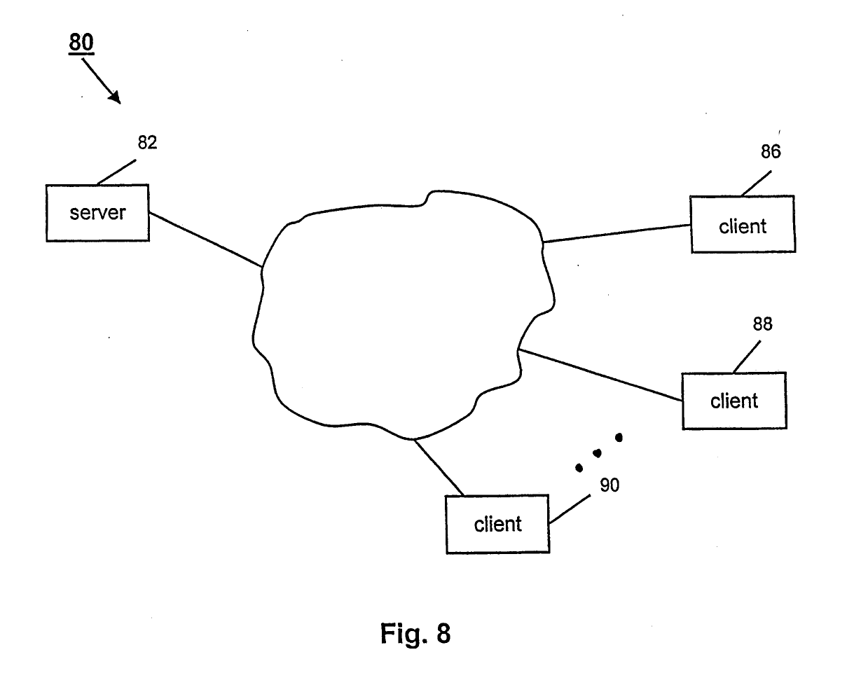

FIG. 8 shows a generalised client-server computer architecture 80, having a single server computer 82 connected to a public or private network 84. A number of client computers 86, 88, 90 also are connected to the network 84. The server 82 serves requested data in requests from the clients 86-90. In the context of the present invention, the server 82 will usually act as the issuer node and the clients 86-90 will act as relying nodes, which download data relating to the CRLs from the issuer node. It is possible, however, that the roles can be reversed.

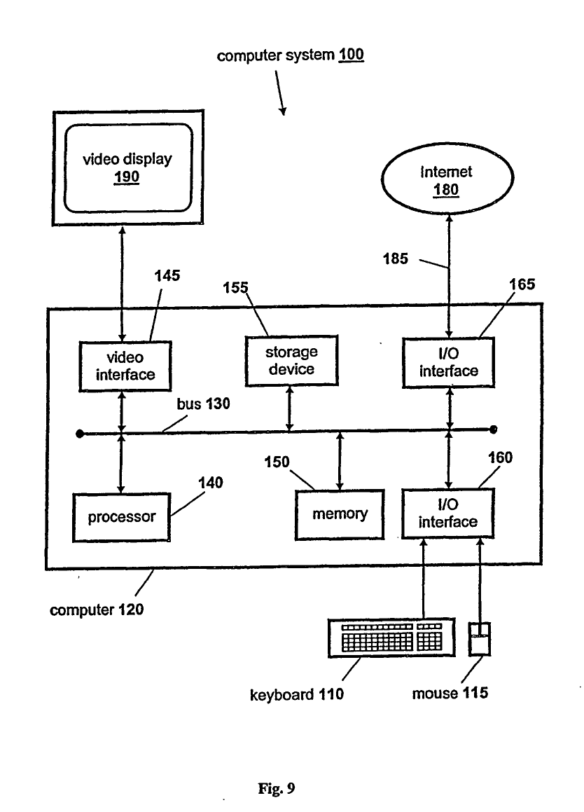

FIG. 9 is a schematic representation of a computer system 100 suitable for executing computer software programs that implement the methods described above, acting as an issuer node or an relying node on a communications network. The issuer node can be either a client or a server in a client-server architecture, as discussed with reference to FIG. 8. Computer software programs execute under a suitable operating system installed on the computer system 100, and may be thought of as a collection of software instructions for implementing particular steps.

The components of the computer system 100 include a computer 120, a keyboard 110 and mouse 115, and a video display 190. The computer 120 includes a processor 140, a memory 150, input/output (I/O) interface 160, communications interface 165, a video interface 145, and a storage device 155. All of these components are operatively coupled by a system bus 130 to allow particular components of the computer 120 to communicate with each other via the system bus 130.

The processor 140 is a central processing unit (CPU) that executes the operating system and the computer software program executing under the operating system. The memory 150 includes random access memory (RAM) and read-only memory (ROM), and is used under direction of the processor 140.

The video interface 145 is connected to video display 190 and provides video signals for display on the video display 190. User input to operate the computer 120 is provided from the keyboard 110 and mouse 115. The storage device 155 can include a disk drive or any other suitable storage medium.

The computer system 100 can be connected to one or more other similar computers via a communications interface 165 using a communication channel 185 to a network, represented as the Internet 180.

The computer software program may be recorded on a storage medium, such as the storage device 155. Alternatively, the computer software can be accessed directly from the Internet 180 by the computer 120. In either case, a user can interact with the computer system 100 using the keyboard 110 and mouse 115 to operate the computer software program executing on the computer 120. During operation, the software instructions of the computer software program are loaded to the memory 150 for execution by the processor 140.

Other configurations or types of computer systems can be equally well used to execute computer software that assists in implementing the techniques described herein.

1. A method for distributing security certificate revocation information on a communications network including the steps of:
an issuer node of said network periodically generating data representative of base certificate revocation lists (CRLs); and
said issuer node periodically generating data representative of incremental CRLs, said incremental CRL data including attributes for a current list of revoked certificates and a digital signature of the most-recent base CRL.

2. A method according to claim 1, further including a relying node requesting from said issuer node to receive current incremental CRL data.

3. A method as claimed in claim 2, wherein said relying node reconstructs said most-recent base CRL by iteratively updating the list of revoked certificates present in the previous base CRL data held by the relying node with the list of revoked certificates held by any intervening incremental CRL data.

4. A method according to any one of the preceding claims, further including said issuer node periodically generating data representative of milestone CRLs, said milestone CRL data including attributes for a current list of expired certificates and said digital signature of the most-recent base CRL.

5. A method as claimed in claim 4, further including a relying node requesting from said issuer node to receive current milestone CRL data and said relying node reconstructing said most-recent base CRL by iteratively:
(i) updating the list of revoked certificates present in the previous base CRL data held by the relying node with the list of revoked certificates held by any intervening incremental CRL data, and
(ii) removing expired revocation certificates according to intervening milestone CRL data.

6. A method as claimed in claim 1, further including said issuer node periodically generating data representative of augmented CRLs, said augmented CRL data including attributes for certificates revoked since the most-recent incremental-CRL data was generated.

7. A method as claimed in claim 6, further including a relying node requesting from said issuer node to receive current augmented CRL data and said relying node reconstructing said most-recent base CRL by iteratively:
(i) updating the list of revoked certificates present in the previous base CRL data held by the relying node with the list of revoked certificates held by any intervening incremental CRL data;
(ii) updating the list of revoked certificates held by an incremental CRL data present in any intervening augmented CRL data; and
(iii) removing expired revocation certificates according to intervening milestone CRL data.

8. An issuer node on a communications network for distributing security certificate revocation information to relying nodes, including processor means for periodically generating data representative of base certificate revocation lists (CRLs), and periodically generating data representative of incremental CRLs, said incremental CRL data including attributes for a current list of revoked certificates and a digital signature of the most-recent base CRL.

9. An issuer node according to claim 8, wherein said processor further periodically generates data representative of milestone CRLs, said milestone CRL data including attributes for a current list of expired certificates and said digital signature of the most-recent base CRL.

10. An issuer node according to claim 9, wherein said processor further periodically generates data representative of augmented CRLs, said augmented CRL data including attributes for certificates revoked since the most-recent incremental-CRL data was generated.

11. An issuer node according to any one of claims 8 to 10, embodied in a server computer of a distributed client-server computer system.

12. An issuer node according to any one of claims 8 to 10, embodied in a client computer of a distributed client-server computer system.

13. A relying node on a communications network for requesting security certificate revocation information from an issuer node, including processor means for reconstructing the most recent base CRL by iteratively updating the list of revoked certificates present in the previous base CRL data held by the relying node with the list of revoked certificates held by any intervening incremental CRL data received from said issuer node, said intervening incremental CRL data includes a digital signature of the most-recent base CRL.

14. A relying node according to claim 13, wherein said processor means further removes expired revocation certificates according to intervening milestone CRL data received from said issuer node, said intervening milestone CRL data includes a digital signature of the most-recent base CRL.

15. A relying node according to claim 13, wherein said processor means further updates the list of revoked certificates held by an incremental CRL data present in any intervening augmented CRL data received from said issuer node, said intervening augmented CRL data includes a digital signature of the most-recent base CRL.

16. A relying node according to any one of claims 13 to 15, embodied in a client computer of a distributed client-server computer system.

17. A relying node according to any one of claims 13 to 15, embodied in a server computer of a distributed client-server computer system.

18. A computer program product comprising a computer program stores by a storage medium, said computer program providing machine readable code that when executed performs the steps of periodically generating data representative of base certificate revocation lists (CRLs), and periodically generating data representative of incremental CRLs, said incremental CRL data including attributes for a current list of revoked certificates and a digital signature of the most-recent base CRL.

19. A computer program product according to claim 18, further comprising code for periodically generating data representative of milestone CRLs, said milestone CRL data including attributes for a current list of expired certificates and said digital signature of the most-recent base CRL.

20. A computer program product according to claim 18, further comprising code for generating data representative of augmented CRLs, said augmented CRL data including attributes for certificates revoked since the most-recent incremental-CRL data was generated.

21. A computer program product comprising a computer program stores by a storage medium, said computer program providing machine readable code that when executed performs the steps of reconstructing a most-recent base CRL by iteratively updating the list of revoked certificates present in the previous base CRL data with the list of revoked certificates held by any intervening incremental CRL data, said intervening incremental CRL data includes a digital signature of the most-recent base CRL.

22. A computer program product according to claim 21, further comprising code for removing expired revocation certificates according to intervening milestone CRL data, said intervening milestone CRL data includes a digital signature of the most-recent base CRL.

23. A computer program product according to claim 22, further comprising code for updating the list of revoked certificates held by an incremental CRL data present in any intervening augmented CRL data, said intervening augmented CRL data includes a digital signature of the most-recent base CRL.
